(19) United States
(12) Patent Application Publication
(10) Pub. No.: US 2015/0033203 A1
(43) Pub. Date: Jan. 29, 2015

(54) METHOD FOR GENERATING EXECUTABLE CODE

(71) Applicants: Philipp Faisst, Rottweil (DE); Igor Erik, Trossingen (DE)

(72) Inventors: Philipp Faisst, Rottweil (DE); Igor Erik, Trossingen (DE)

(73) Assignee: PAADE GMBH, Balgheim (DE)

(21) Appl. No.: 14/367,279

(22) PCT Filed: Dec. 23, 2011
(86) PCT No.: PCT/EP2011/006560

§ 371 Date: Sep. 16, 2014

(51) Int. Cl. G06F 9/44

(52) U.S. Cl. CPC G06F 8/30
USPC 717/106

(57) ABSTRACT

The invention relates to a method for generating executable code (10, 10′) that is intended to be executed on a mobile end device (12, 12′) having at least one app builder unit (16) with at least one memory unit (18) in which at least one base code (24, 24′) is stored, and which has at least one input module (20) and at least one generating module (22), wherein required functions and/or data (D1, D2, D3, D4) are entered through the input module (20) by a user in a first procedural stage (SI) and the generating module (22) embeds at least part of the required functions and/or data (D1, D2, D3, D4) in the base code (24, 24′) in a later procedural stage (S4).

### STATE OF THE ART

The invention relates to a method for generation of executable code in accordance with claim 1.

It is known to program programs that are intended to be run on smartphone and the like separately. For this purpose, programmers use code modules and link these to produce desired functions, using their programming knowledge.

### Advantages of the Invention

The invention relates to a method for generation of executable code that is intended to be executed on a mobile end device, having at least one app builder unit that has at least one memory unit in which at least one base code is stored, at least one input module, and at least one creation module, whereby in a first method section, desired functions and/or data are input by way of the input module by an operator, and in a later method section, the creation module embeds at least part of the desired functions and/or data in the base code. “Executable code” should particularly be understood to mean a sequence of computer instructions, particularly assembler and/or machine code, written into a packet, particularly a file, which is intended to allow an at least semi-automatic program to run. Preferably, the packet and/or the instructions are adapted to, particularly specifically compiled for specific conditions, particularly to a processor to be used, which particularly works with the RISC command set and/or a further development of the latter and/or the architecture of which is based on ARM technology, and/or to an operating system within the scope of which the executable code is to be executed. A “mobile end device” should particularly be understood to mean an end device having a weight of less than 2 kg, particularly less than 1 kg, advantageously less than 500 g, preferably less than 200 g. Preferably, a mobile end device has at least one off-grid power supply, particularly a rechargeable battery unit and/or a solar generator unit. Preferably, the mobile end device has at least one contact-sensitive, particularly capacitative, resistive and/or inductive display, which serves as an operator interface. In particular, the mobile end device is configured as a mobile telephone, particularly as smartphone, or as a tablet PC. In particular, the mobile end device has at least one communication interface, particularly at least one GPRS, EDGE, UMTS and/or W-LAN interface. In particular, the mobile end device has at least one position sensor, particularly a GPS receiver. In particular, the mobile end device has at least one acceleration sensor. In particular, the mobile end device has at least one video, photo and/or audio recording unit. Preferably, the mobile end device has at least one operating system optimized for mobile purposes, particularly with regard to display on displays having a screen diagonal of less than 20 cm, advantageously less than 15 cm and/or with regard to operation by means of touch display, for example iOS, Android, Windows Phone and/or Blackberry OS. An “app builder unit” should particularly be understood to be an at least semi-automatic unit. Preferably, an app builder unit has at least one processing unit, at least one memory unit, and at least one operating program stored in the memory unit, which program is intended to be executed by the processing unit. Preferably, the memory unit and the processing unit are integrated into a data processing system, particularly a PC, preferably a server. Alternatively, it is possible that the memory unit and the processing unit are connected with one another by way of a network connection, particularly integrated into different data processing systems. A “memory unit” should particularly be understood to mean a unit that is intended to store data, particularly digitally, preferably in non-volatile manner. Preferably, the memory unit is formed by at least one hard drive, particularly SSD. A “base code” should particularly be understood to mean an incomplete programming code present in a preferably object-oriented programming language, particularly a high-level language, for example object c, Java, C++, Visual Basic, or something comparable. In particular, the base code has at least a first code module that is intended to make a connection to input and/or output functions of the mobile end device, particularly GPS functions, display functions, communication functions, vibration functions, sensor functions, video and/or audio recording functions, available. In particular, at least the first code module is intended to access interfaces that are made available by the operating system of the mobile end device. In particular, the base code has at least a second code module that is intended to make a connection possibility with a database unit available. An “input module” should particularly be understood to mean an interface between the operator and the app builder unit. “Embedding” of functions and/or data in the base code should particularly be understood to mean that code modules assigned to the functions, particularly a map display, GPS information, a database access and/or other possible functions are integrated into the base code at a suitable location, or that the data, particularly graphic data and/or content data, are stored in a memory area of the base code. In particular, the base code, modified by means of integration, preferably present in a high-level language, is converted to assembler and/or machine language subsequent to its embedding, particularly compiled, by means of the creation module. In particular, a simple possibility for generating at least one executable code can be made available.

Furthermore, it is proposed that the input module is operated by way of remote access. Operation by means of “remote access” should particularly be understood to mean operation by way of a network interface, particularly by way of at least one telecommunication line, particularly DSL, ISDN, or something comparable. In particular, the app builder unit has at least one network interface. In particular, the app builder unit is is connected with at least one network, particularly at least the Internet, at least part of the time, particularly at least 80%, advantageously at least 95%, preferably at least 99% of a day, a month and/or a year. In particular, the app builder unit offers a web interface that the operator can access by way of the Internet. In particular, simple operation can be achieved. In particular, the result can be achieved that the app builder unit can be operated by more than one operator at the same time. In particular, access to the app builder unit can be made available by any desired end devices, particularly PCs, smartphones or the like.

Furthermore, it is proposed that the operator does not need to demonstrate any knowledge of a written programming language, particularly does not need to have any programming knowledge at all, in order to carry out the first to later method sections. The expression that the operator “demonstrates knowledge of a written programming language” should particularly be understood to mean that the operator knows and/or can use at least basic syntax and/or semantics of at least one written high-level language, particularly object c, Java, C++, VB, or something comparable, and/or an assembler language and/or machine code. In particular, it is possible that the operator produces functional connections between individual desired functions and/or data by means of intuitive linking, particularly drag and drop and/or line linking, of objects abstracted as function blocks. In particular, functions blocks that allow an input of mathematical functions are provided. In particular, the input unit makes an input area at least similar to a graphic programming language such as G, for example, available. In particular, a simple, efficient and/or intuitive possibility for generation of executable code can be made available. In particular, any operators can generate their own executable code, tailored to their needs.

Furthermore, it is proposed that the input module guides the operator by means of at least one configuration menu in a first method section. In particular, the operating program of the app builder unit, particularly a web interface, has a menu structure that makes it possible for the operator to jump back and forth between any desired configuration points of the configuration menu, at least during the first method section, in order to make changes and/or corrections. In particular, the app builder unit stores functions and/or data added to a new project, in order to allow interruption of the configuration and subsequent continuation. In particular, simple configuration can be made possible.

Furthermore, it is proposed that at least industry data are entered in the first method section, particularly at a first point in the configuration menu. “Industry data” should particularly be understood to mean data that describe an application area of the executable code to be generated. In particular, in this connection a distinction is made between an application for goods and services. Furthermore, a distinction can be made between different industry-specific effects to be triggered with the executable code, particularly processing of a purchase, display of at least one item of information, reservation of a service and/or other possible effects. In particular, different functions and/or data, which should and/or could be embedded, are proposed to the operator by the app builder unit as a function of input industry data. In particular, the app builder unit hides functions and/or data that are unsuitable for the input industry data, particularly in the configuration menu. In particular, hidden functions and/or data can be made visible again by the operator. In particular, a better overview and/or easier configuration can be achieved.

Furthermore, it is proposed that in the first method section, particularly at a second point of the configuration menu, at least layout properties are input by the operator. “Layout properties” should particularly be understood to mean properties that influence an optical appearance, at least of the subsequent executable code, on the mobile end device. In particular, the operator determines a number, a size, a labeling and/or a position of buttons. In particular, the app builder unit suggests layout properties on the basis of input industry data. In particular, the operator establishes graphic data, particularly a color scheme and/or at least a background graphic. In particular, the operator establishes a size and/or a position of at least one data area.

Furthermore, it is proposed that in the first method section, the operator inputs at least content data. “Content data” should particularly be understood to mean data that relate to an effect of the executable code that is to be achieved. In particular, goods and/or services data are input as content data. In particular, content data are data that change over time. The result can particularly be achieved that contents can already be output, particularly displayed, in a first execution of the executable code that has been generated.

Furthermore, it is proposed that in at least one first intermediate step, at least part of the desired functions and/or data are stored in a database unit, particularly one that is publicly accessible. Preferably, the first intermediate step lies ahead of the first and the later method section, in terms of time. Alternatively, it is possible that the first intermediate step takes place as one of the first or as the first step of the later method section. In particular, at least the content data are stored in a database unit. In particular, at least part of the layout data, particularly at least the graphic data, are stored in the database unit. A “database unit” should particularly be understood to mean a unit that has at least one data storage object and/or data storage object. In particular, the data storage object and/or data storage object differs from a pure hard disk. In particular, the database unit has an operating program that categorizes data of the data storage object and/or data storage object and/or stores them in linked manner. In particular, the database unit sends back requested data as a function of parameters of a command path and/or stores data stored in parameters of the command path. In particular, the database unit is integrated into a data processing system that is connected with at least one network, particularly at least the Internet, at least part of the time, particularly at least 80%, advantageously at least 95%, preferably at least 99% of a day. In particular, the executable code, after being generated, is intended to connect with the database unit, preferably automatically, particularly regularly, in order to update content data, layout data and/or other possible data. “Publicly accessible” should particularly be understood to mean that more than just the operator, particularly at least users who subsequently execute the executable code that has been generated, can access the data of the database unit, particularly by way of the executable code that is to be generated. In particular, only new data are transmitted during an update, in order to reduce the scope of a data transfer and/or particularly costs. In particular, simple changeability of at least the content data can be achieved. In particular, it is possible to do without generation of a new executable code and, in particular, without the resulting large data transfer, particularly on the user side.

Advantageously, it is proposed that the app builder unit has at least one further creation module, which generates at least one preview packet in at least a second intermediate step. Preferably, the second intermediate step takes place before the later method section. A “preview packet” should particularly be understood to mean a data packet in which the desired functions and/or data are stored. In particular, the preview packet is transmitted to a mobile end device within the scope of the second or a further intermediate step, particularly indirectly by way of a data storage unit, particularly a database unit, to which the mobile end device has access, particularly by way of a special executable code. In particular, the mobile end device has a special executable code that is intended to simulate a functionality and/or an appearance of the executable code to be generated, using the preview packet, whereby greater processing capacity is required in comparison with the executable code to be generated. In particular, the preview packet is independent of an operating system. In particular, a convenient possibility can be made available for testing a functionality and/or an appearance of the executable code to be generated, whereby it is possible to do without particularly complicated, time-consuming and/or cost-intensive publication, particularly generation and/or insertion into a sales platform of the executable code.

Furthermore, it is proposed that at least two base codes are stored in the storage unit, from which the creation unit, in the later method section, generates at least two executable codes with at least equivalent, preferably the same functionality for at least two different mobile end devices by means of embedding at least one equal part of the desired functions and/or data into the base code, in each instance. Two mobile end devices are particularly “different” if they have at least different operating systems. In particular, the base codes are present in different programming languages. The result can particularly be achieved that different executable codes that are intended for operation with different mobile end devices, in each instance, have the same and/or equivalent appearance and the same and/or equivalent functionality. In particular, time can be saved that would be needed for separate generation of different codes with at least equivalent functionality.

Furthermore, it is proposed that the app builder unit, in a final method step, inserts the at least one generated executable code into at least one sales platform. “Insertion into a sales platform” should particularly be understood to mean that forms, particularly web forms of the sales platform are automatically filled out and/or that verification, particularly signing of the executable code is automatically carried out. In particular, the executable code can be procured, particularly downloaded by any users after it has been inserted into the sales platform. In particular, the app builder unit is intended to insert executable codes that have been generated for execution on different mobile end devices into different sales platforms. In particular, the operator establishes prices for the executable code and/or makes it available free of charge, independent of or depending on the sales platform.

### DRAWINGS

Further advantages are evident from the following description of the drawings. In the drawings, an exemplary embodiment of the invention is shown. The drawings, the description, and the claims contain numerous characteristics in combination. A person skilled in the art will also consider the characteristics individually, for practical purposes, and will combine them to arrive at practical further combinations.

The figures show:

FIG. 1 a schematic representation of a method according to the invention in a schematic representation, and

FIG. 2 systems according to the invention in a schematic representation.

### DESCRIPTION OF THE EXEMPLARY EMBODIMENT

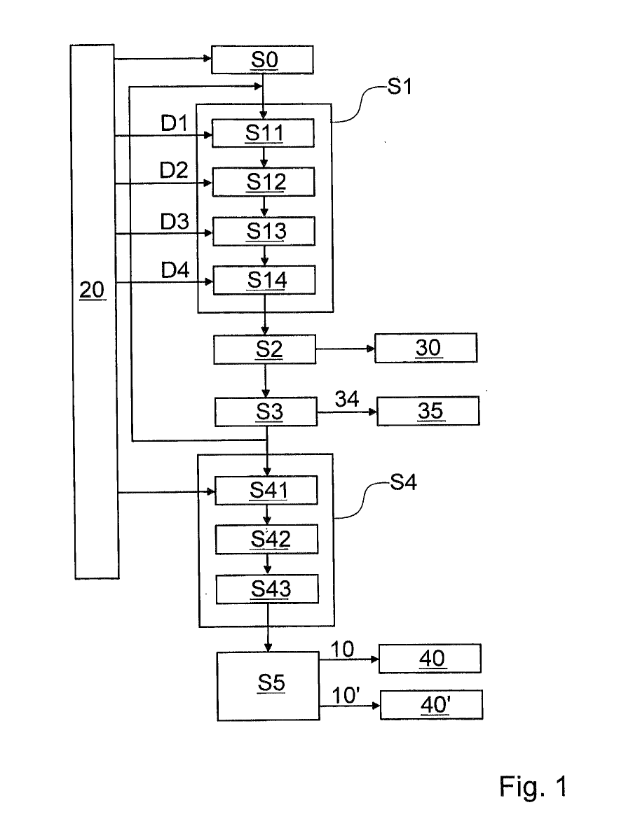

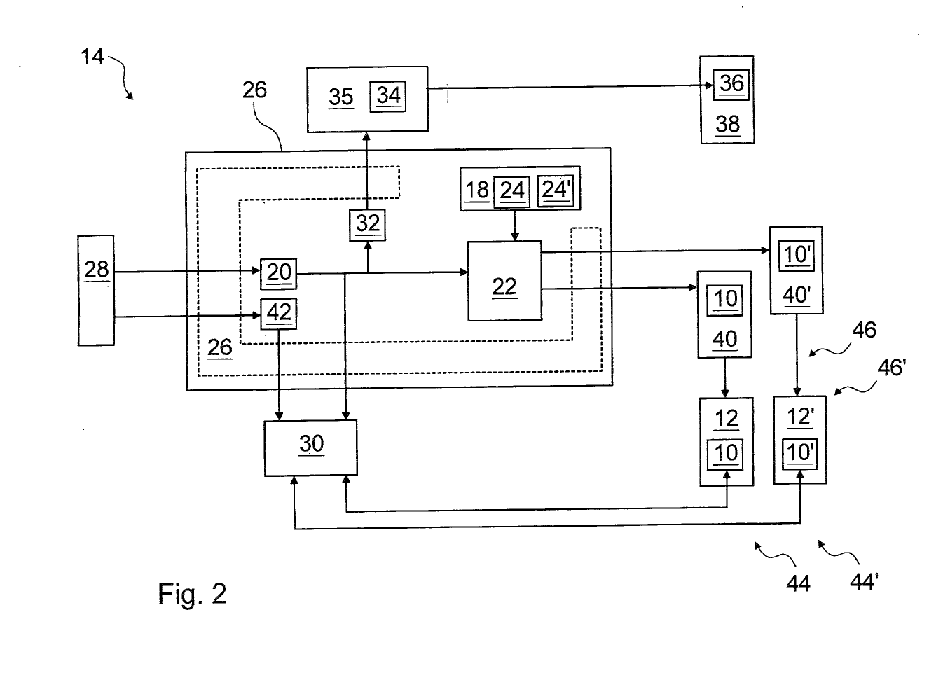

FIG. 1 shows the sequence of a method for generation of executable code 10, 10′ that is intended to be executed on mobile end devices 12, 12′. The mobile end devices 12, 12′ are configured as smartphones with an i-OS or Android operating system. The method is carried out with a system 14 that has an app builder unit 16 (FIG. 2). The app builder unit 16 has a memory unit 18, an input module 20, and a creation module 22. Two base codes 24, 24′ are stored in the memory unit 18. The app builder unit 16 furthermore has a network interface 26 that is intended to connect the app builder unit 16 to the Internet. The system 14 furthermore has a remote access interface 28 that is intended to access the input module 20 of the app builder unit 16 by way of the Internet and the network interface 26. The remote access interface 28 is configured as a PC here, but it can also be configured as any desired IT device. The input module 20 is operated by way of remote access.

The method begins, triggered by an operator, in that the latter calls up a web interface that is made available by the input module 20, in an initial method step S0. In this connection, it is provided that the operator signs on to a user account before continuing the method.

In a first method section S1, the operator enters desired functions and/or data D1, D2, D3, D4 by way of the input module 20. In this connection, no knowledge of the operator concerning a written programming language is required to execute the method. The input module 20 guides the operator through a configuration menu in the first method section S1.

In the first method section S1, the operator inputs industry data D1 in a first configuration step that corresponds to a method step S11, by way of the input module 20. In this connection, selection possibilities can be hospitality, search service, sale of goods or the like. The app builder unit 16 suggests corresponding layout and function suggestions to the operator in the next method steps S12, S13, as a function of the industry data D1 that are entered.

In a subsequent configuration step that corresponds to a method step S12, the operator enters layout properties D2. The app builder unit 16 makes the possibility available to the operator of choosing among different, particularly suitable, ready-made configuration variants determined on the basis of the industry data D1. The operator can also, if the suggestions appear unsuitable, have further ready-made configuration variants be displayed for selection, can adapt a ready-made configuration variant, or can establish positions, sizes, and items of data areas and buttons independently. Furthermore, the operator is given the possibility of selecting among different designs, color schemes, and background images, or of configuring a design, a color scheme, and background images on his/her own. Furthermore, menu structures and their graphic representation are input by the operator.

In the first method section S1, the operator enters desired functions D3. The desired functions D3 are connected with desired buttons. Suitable functions D3 are suggested to the operator on the basis of input industry data D1 and input layout properties D2. This is done in a configuration step of the configuration menu that corresponds to a method step S13. The operator determines what action, for example display of a menu, input of data into a database unit 30, read-out of data from the database unit 30, termination or hiding of the executable code 10, 10′, a map display, a search function that takes over current GPS coordinates as parameters, for example, transmission of a specific coordinate or address, or one selected from a data set, to a routing function of the mobile end terminal 12, 12′, a routing method, an access to a communication system such as email, telephony or instant messaging, recording and/or transmission of video and/or audio and/or other possibilities are executed upon activation of the button, in each instance, or what functions were executed. Furthermore, the operator enters desired functions D3 by establishing what action or actions are supposed to follow a specific event that is based on sensor signals, for example, such as from an acceleration sensor, a camera or a microphone. Upon conclusion of this method step S13, the app builder unit 16 points out to the operator any missing important functions, for example a termination function, and any unassigned buttons. Alternatively or additionally, it is possible that the app builder unit 16 displays lists during the first method section S1, in which unassigned buttons or functions that have not yet been used are listed. The app builder unit 16 gives the operator the possibility, by way of the input module 20, of inputting more complex functions, for example for processing of sensor signals and/or for combining multiple functions of the mobile end device 12, 12′, by way of an interface that is comparable with a graphic programming language.

In a further method step S14 of the first method section S1 during configuration, content data D4 are entered by the operator. In this connection, content data are data that are supposed to be displayed to a user as a function of interactions by the user with the finished executable code 10, 10′, in data areas of the layout, for example data concerning one or more products, goods or services that an operator would like to offer the user by way of the executable code, a list or table of data, for example product data, location data or user data, images, texts, and comparable items. The operator furthermore establishes which of the content data are only supposed to be stored in the database unit 30, for example in the case of large, rapidly changing data sets, in order to avoid large data transmissions. Furthermore, it is possible that content data are stored in a further database unit and that access to these further units was established in method step S13 per function, in other words access data for this further database unit were stored.

Once input of data has been concluded, the operator terminates the configuration by way of a corresponding function of the configuration menu, and the method is continued. The operator can switch between any desired method steps S11, S12, S13, S14 of the method section S1, using the configuration menu.

The database unit 30 is an integral part of the system 14. In this connection, the database unit 30 is connected with the app builder unit 16 by way of the Internet. In a first intermediate step S2, part of the desired functions and/or data D1, D2, D3, D4 are stored in the database unit 30. Both the content data D4 and the graphic data concerning design, color scheme, and background image are stored in the database unit 30, so that an operator can adapt the appearance of the executable code 10, 10′ subsequently or seasonally.

The app builder unit 16 has a further creation module 32. In a second intermediate step S3, the further creation module 32 generates a preview packet 34. The preview packet 34 comprises all the functions and/or data D1, D2, D3, D4 input during the first method section S1. The preview packet 34 is stored in a database unit 35. An executable code 36, the preview app, is provided, which is executed on a mobile end device 38 and in this connection simulates a functionality of the executable code 10, 10′ that is to be executed, using the preview packet 34. For this purpose, the preview app connects with the database unit 35, identifies itself with access data of the operator, and gives the operator the possibility of choosing among different preview packets 34 stored in the database unit 35. The preview packet 34 is analyzed and interpreted by the preview app.

The app builder unit 16 makes the possibility available to the operator of skipping over the second intermediate step S3.

If the operator is satisfied with the results of the preview packet 34 or skips the intermediate step S3, the work continues with a later method section S4. Alternatively, the operator can return to the first method section S1.

At the beginning of the later method section S4, in a method step S41, the operator is prompted to indicate for what operating systems a suitable executable code 10, 10′ is supposed to be created. Accordingly, the creation module 22 embeds an equal part of the desired functions and/or data D1, D2, D3, D4 into the base codes 24, 24′ in the later method section S4. In this connection, two executable codes 10, 10′, for example, are generated, with equivalent functionality for two different mobile end devices 12, 12′. The desired functions F3 are made available by means of automatic insertion of suitable code modules, specially prepared for this purpose, into the base code 24, 24′. A first one of the base codes 24 and the corresponding code modules are written in object c. A second base code 24′ and the corresponding code modules are written in Java. In a method step S42, a first executable code 10, which is suitable for use with the i-OS operating system on the first mobile end device 12, is generated from the first base code 24. In a method step S43, a second executable code 10′, which is suitable for use with the Android operating system on the second mobile end device 12′, is generated from the second base code 24′. In this connection, graphic data and content data D4 are kept on hand in a memory area that is excluded from compilation, and suitably appended to the executable code 10, 10′.

In a further development of the invention, it is possible that more than two base codes, from which executable codes having the same functionality are created, are kept on hand for different operating systems.

Subsequent to generation of the executable code 10, 10′, in a final method step S5, the generated executable codes 10, 10′ are inserted into corresponding sales platforms 40, 40′. The sales platforms 40, 40′ are configured as online stores that are specialized for executable codes for the corresponding operating systems, in each instance. Alternatively or additionally, insertion into sales platforms that go beyond one operating system is possible. If an operator did not indicate any user data with regard to the sales platforms 40, 40′, the app builder unit 16 automatically creates user accounts on these sales platforms 40, 40′. Furthermore, the app builder unit 16 automatically executes referencing and signing procedures requested by a sales platform 40, 40′ for the executable code 10, 10′.

Furthermore, the app builder unit 16 has a maintenance module 42. The operator can access the maintenance module by way of a web interface, from any desired end devices, particularly also mobile end devices or PCs. The operator can change the graphic data and the content data D4 that are stored in the database unit 30, by way of the maintenance module 42. Furthermore, insertions of a user account of the operator for the app builder unit 16 and the user accounts for the sales platforms 40, 40′ can be administered by means of the maintenance module 42.

A module that brings about regular, daily updating of the generated executable code 10, 10′ on the basis of data stored in the database unit 30 is provided in the base code 24, 24′. In this connection, only changed data are transmitted, in order to keep the data traffic low.

Furthermore, FIG. 2 shows two systems 44, 44′ with the app builder unit 16 and a mobile end device 12, 12′, in each instance, which is intended to execute the executable code 10, 10′ generated by the app builder unit 16.

Furthermore, FIG. 2 shows two systems 46, 46′ having a mobile end device 12, 12′, in each instance, an executable code 10, 10′, in each instance, and at least one database unit 30 that is intended to store part of the desired functions and/or data D1, D2, D3, D4 of the executable code in publicly accessible manner.

Furthermore, it can be provided that the database units 30, 35 are configured as a single database unit.

### REFERENCE SYMBOLS

10 executable code
10′ executable code
12 mobile end device
12′ mobile end device
14 system
16 app builder unit
18 memory unit
20 input module
22 creation module
24 base code
24′ base code
26 network interface
28 remote access interface
30 database unit
32 creation module
34 preview packet
35 database unit
36 executable code
38 mobile end device
40 sales platform
40′ sales platform
42 maintenance module
44 system
44′ system
46 system
46′ system
D1 industry data
D2 layout properties
D3 functions
D4 content data
S0 method step
S1 method section
S11 method step
S12 method step
S13 method step
S14 method step
S2 intermediate step
S3 intermediate step
S4 method section
S41 method step
S42 method step
S43 method step
S5 method step

1. A method for generation of executable code (10, 10′) that is intended to be executed on a mobile end device (12, 12′), having at least one app builder unit (16) that has at least one memory unit (18) in which at least one base code (24, 24′) is stored, at least one input module (20), and at least one creation module (22), wherein in a first method section (S1), desired functions and/or data (D1, D2, D3, D4) are input by way of the input module (20) by an operator, and in a later method section (S4), the creation module (22) embeds at least part of the desired functions and/or data (D1, D2, D3, D4) in the base code (24, 24′).

2. The method according to claim 1, wherein the input module (20) is operated by remote access.

3. The method according to claim 1, wherein the operator does not need to demonstrate any knowledge of a written programming language in order to carry out the first to later method section (S1, S4).

4. The method according to claim 1, wherein the input module (20) guides the operator through at least one configuration menu during the first method section (S1).

5. The method according to claim 1, wherein at least industry data (D1) are entered by the operator in the first method section (S1).

6. The method according to claim 1, wherein at least layout properties (D2) are entered by the operator in the first method section (S1).

7. The method according to claim 1, wherein at least content data (D4) are entered by the operator in the first method section (S1).

8. The method according to claim 1, wherein in at least a first intermediate step (S2), at least part of the desired functions and/or data (D1, D2, D3, D4) are stored in a database unit (30).

9. The method according to claim 1, wherein the app builder unit (16) has at least one further creation module (32) that generates at least one preview packet (34) in at least a second intermediate step (S3).

10. The method according to claim 1, wherein at least two base codes (24, 24′) are stored in the memory unit (18), from which the creation unit, in the later method section (S4), generates at least two executable codes (10, 10′) with at least equivalent functionality for at least two different mobile end devices (12, 12′), by means of embedding at least one equal part of the desired functions and/or data (D1, D2, D3, D4) into the base code (24, 24′), in each instance.

11. The method according to claim 1, wherein the app builder unit (16), in a final method step (S5), inserts the at least one generated executable code (10, 10′) into at least one sales platform (40, 40′).

12. A system having at least one app builder unit (16) for execution of a method according to claim 1.

13. The system according to claim 12, further comprising at least one remote access interface (2B), which is intended to access an input module (20) of the app builder unit (16).

14. The system according to claim 12, further comprising at least one mobile end device (12, 12′) that is intended to execute at least one executable code (10, 10′) generated by the app builder unit (16).

15. The system according to claim 12, further comprising at least one database unit (30), that is intended to store at least part of the desired functions and/or data (D1, D2, D3, D4) entered in the first method section (S1).

16. A base code that is intended to be converted into an executable code (10, 10′) by means of embedding of desired functions and/or data (D1, D2, D3, D4) into a method according to claim 1.

17. An executable code that was generated by means of a method according to claim 1.

18. The executable code that is intended to be executed on a mobile end device (38) and, in this connection, to simulate the functionality of an executable code (10, 10′) according to claim 17, using a preview packet (34) generated by at least one further creation module of the at least one app builder unit.

19. A system having at least one mobile end device (12, 12′), at least one executable code (10, 10′) according to claim 17, and at least one database unit (30), which unit is intended to store at least part of the desired functions and/or data (D1, D2, D3, D4) of the executable code (10, 10′).
